(19) United States
(12) Patent Application Publication
(10) Pub. No.: US 2023/0151501 A1
(43) Pub. Date: May 18, 2023

(54) ELECTROLYTIC CONVERSION OF CARBON-CONTAINING IONS USING POROUS METAL ELECTRODES

(71) Applicant: THE UNIVERSITY OF BRITISH COLUMBIA, Vancouver (CA)

(72) Inventors: Curtis BERLINGUETTE, Vancouver (CA); Zishuai ZHANG, Vancouver (CA)

(21) Appl. No.: 17/919,455

(22) PCT Filed: Apr. 16, 2021
(86) PCT No.: PCT/CA2021/050525

§ 371 Date: Nov. 1, 2022

Related U.S. Application Data
(60) Provisional application No. 63/011,620, filed on Apr. 17, 2020.

(51) Int. Cl. C25B 11/032; C25B 1/23; C25B 9/23; C25B 1/04; C25B 11/052; C25B 11/061; C25B 11/081; B01D 53/96

(52) U.S. Cl. CPC C25B 11/032; C25B 1/23; C25B 9/23; C25B 1/04; C25B 11/052; C25B 11/061; C25B 11/081; B01D 53/965; B01D 53/62

(57) ABSTRACT

Methods and apparatus incorporating porous metallic electrodes for electrolytic conversion of carbon-containing ions are disclosed. A electrochemical cell has an anode, a porous metallic electrode which serves as a cathode, and an ion exchange membrane between the anode and the porous metallic electrode. Water dissociates into hydroxide ions and hydrogen ions at the ion exchange membrane. The hydroxide ions permeate towards the anode, and the hydrogen ions permeate towards the porous metallic electrode. A carbon-containing solution is supplied to the porous metallic electrode. The carbon-containing solution reacts with the hydrogen ions to form one or more carbon-containing intermediate products. One of the carbon-containing intermediate products participate in a reduction reaction at the porous metallic electrode to form one or more carbon-containing resulting products. In some embodiments, the carbon-containing solution comprises a solution containing bicarbonate. One application of the methods and apparatus is in the field of carbon capture.

### CROSS-REFERENCE TO RELATED APPLICATIONS

This application claims priority from U.S. application No. 63/011,620 filed 17 Apr. 2020 and entitled FREE-STANDING POROUS METALLIC ELECTRODE AND USE THEREOF which is hereby incorporated herein by reference for all purposes. For purposes of the United States of America, this application claims the benefit under 35 U.S.C. § 119 of U.S. application No. 63/011,620 filed 17 Apr. 2020 and entitled FREE-STANDING POROUS METALLIC ELECTRODE AND USE THEREOF.

### FIELD

This invention relates generally to methods and apparatus incorporating porous metallic electrodes for electrolytic conversion of carbon-containing ions or molecules in solution (carbon-containing solutions). Specific embodiments provide electrochemical cells and methods which apply porous metallic electrodes to convert dissolved bicarbonate into one or more carbon-containing compounds.

### BACKGROUND

Carbon dioxide is the primary greenhouse gas emitted through human activities. Carbon capture is a way to reduce the emission of greenhouse gases Carbon capture technologies may capture carbon dioxide from the atmosphere or a point source. Captured carbon dioxide may be stored and/or converted to useful carbon-based compounds. Such compound-based compounds may be used to form chemicals or fuels of economic value. One example is carbon monoxide.

Conventional carbon capture processes involve using basic solutions to capture carbon dioxide. An example of such processes is discussed in Keith, D. W., Holmes, G., St. Angelo, D. & Heidel, K. A Process for Capturing CO₂ from the Atmosphere. Joule 2, 1573-1594 (2018). Such processes involve high temperature and pressurization steps which are both energy and capital intensive.

The inventors have recognised a general need for improved methods and electrochemical cells for electrolyzing carbon-based solutions such as a solution containing bicarbonate. There is a particular need for such methods and cells to facilitate the capture of CO₂ from the atmosphere or a point source to form useful products without requiring high temperature or pressurization processes.

### SUMMARY

This application has a number of aspects. These include, without limitation:
use of a porous metallic electrode to electrolyze carbon-containing solutions;
apparatus incorporating a porous metallic electrode for electrolyzing carbon-containing solutions;
methods for electrolyzing carbon-containing solutions;
methods for capturing atmospheric carbon dioxide;
methods and apparatus which react bicarbonate at a porous metallic electrode such as a silver foam electrode to yield products such as carbon monoxide.

One aspect of the invention provides an electrochemical cell incorporating a porous metallic electrode for electrolyzing carbon-containing solutions. The electrochemical cell is capable of producing useful products. The porous metallic electrode serves as a cathode. In some embodiments, the porous metallic cathode is made of a foam material.

The electrochemical cell comprises an anode, the porous metallic electrode, and an ion exchange membrane between the anode and the porous metallic electrode. The ion exchange membrane may be a bipolar membrane. The bipolar membrane may be adapted to dissociate water molecules into hydroxide ions and hydrogen ions. The hydroxide ions may permeate toward the anode. The hydrogen ions may permeate toward the porous metallic electrode.

In an example embodiment, the carbon-containing solution is a solution containing bicarbonate. Bicarbonate is not electrocatalytically active. Bicarbonate may be supplied to the bipolar membrane. Bicarbonate may react with the permeated hydrogen ions on an interface of the bipolar membrane to form one or more carbon-containing intermediate products. In some embodiments, the carbon-containing intermediate product is carbon dioxide. The conversion of bicarbonate to carbon dioxide results in the formation of an electrocatalytically active species.

The carbon-containing intermediate product participates in a reduction reaction on the porous metallic electrode. The reduction reaction forms one or more carbon-containing resulting products. The one or more carbon-containing resulting products may comprise carbon monoxide.

In some embodiments, the electrochemical cell comprises a flow cell. The flow cell may for example comprise a zero-gap electrolyzer. In such embodiments, the anode and porous metallic electrode are pressed against opposing surfaces of the ion exchange membrane. A cathode and anode flow plate may be arranged to press against the surfaces of the porous metallic electrode and anode respectively. A catholyte reservoir may be fluidly connected to supply the carbon-containing solution to the cathode flow plate. An anolyte reservoir may be fluidly connected to supply anode electrolyte to the anode flow plate.

One aspect of the invention provides methods of applying a electrochemical cell of the general type described above to electrolyze a carbon-containing solution.

The method may be tuned to optimize current efficiency of the electrolysis reaction by adjusting one or more of the porosity of the porous metallic electrode and/or the electrochemical surface area of the porous metallic electrode and/or the specific type of metal used for the porous metallic electrode and/or the temperature of the carbon-containing solution being supplied to the porous metallic electrode and/or the concentration of the carbon-containing solution.

The current efficiency may be increased by increasing the porosity of the porous metallic electrode. In some embodiments, the porosity of the porous metallic electrode is greater than about 40%. In some embodiments, the porosity of the porous metallic electrode is in the range from about 70% to about 85%.

Examples of operating conditions that are favorable in the electrolytic conversion of bicarbonate include:
concentration of a solution containing bicarbonate in the range of from about 3 M to about 6 M;
operating temperature in the range of from about 60° C. to about 80° C.;
operating pressure in the range of from about 4 to about 10 atm.

The electrochemical cell and methods generally described above enable the processing of a carbon-containing solution to yield carbon-containing resulting products with high faradaic efficiency. In some embodiments, the faradaic efficiency of the reduction reaction is greater than about 40%, or greater than about 60%. The high faradaic efficiency may be achieved with relatively low current density. The current density may, for example, be in the range of from about 50 mA cm⁻² to about 500 mA cm⁻². For example, in some embodiments, the high faradaic efficiency can be achieved at an applied current density of about 100 mA cm⁻².

One aspect of the invention provides methods and apparatuses for combining a bicarbonate electrolysis reaction with an upstream carbon capture process to convert gaseous carbon dioxide (CO₂) captured from the atmosphere or a point source into useful carbon-containing products.

In some embodiments, the upstream carbon capture process comprises reacting a chemical sorbent with the ambient air or emissions from a point source. An example carbon capture process applies carbon dioxide scrubbing that comprises receiving a flow of flue gas at an inlet of a scrubbing system and directing the flow of flue gas to a gas liquid contactor or chamber. The flue gas contacts the chemical sorbent at the gas liquid contactor or chamber. In an example embodiment, carbon dioxide in the flue gas reacts with the chemical sorbent (e.g., a basic solution) to form a solution containing bicarbonate. The scrubbing system may comprise an outlet to deliver the solution containing bicarbonate out of the system.

In some embodiments, the outlet of the scrubbing system is fluidly connected to an electrochemical cell. The electrochemical cell includes a porous metallic electrode which serves as a cathode. The solution containing bicarbonate may be delivered from the scrubbing system to a cathode region of the electrochemical cell. In such embodiments, the bicarbonate participates in a chemical reaction at the ion exchange membrane to form carbon dioxide. The carbon dioxide is then reduced at the porous metallic electrode to form one or more carbon-containing resulting products.

In some embodiments, the reduction of the carbon dioxide also forms a liquid sorbent by-product. The liquid sorbent by-product may be supplied to the chamber of the scrubbing system for subsequent carbon capture reactions with the flue gas.

Further aspects and example embodiments are illustrated in the accompanying drawings and/or described in the following description.

It is emphasized that the invention relates to all combinations of the above features, even if these are recited in different claims.

### BRIEF DESCRIPTION OF THE DRAWINGS

The accompanying drawings illustrate non-limiting example embodiments of the invention.

FIG. 1 is a schematic diagram combining an example conventional carbon dioxide capture process with a carbon dioxide capture process according to an example embodiment of the invention.

FIG. 2 is a schematic diagram of an electrochemical cell according to an example embodiment of this invention.

FIG. 3 is a flow chart showing steps in a method for electrolyzing bicarbonate using the FIG. 1 electrochemical cell according to an example embodiment of the invention.

FIG. 4 is a flow chart showing steps in a carbon dioxide capture method according to an example embodiment of the invention.

FIG. 5 is a schematic diagram of a porous metallic electrode incorporated in the FIG. 2 electrochemical cell according to an example embodiment of the invention.

FIGS. 6A, 6B, and 6C are scanning electron microscope (SEM) images of three foam electrodes used in the comparative experiments described in the Examples section. FIG. 6A is a SEM image of a silver foam (referred to as “Foam”). FIG. 6B is a SEM image of an etched silver foam that has been treated with dilute nitric acid (referred to as “Foam/E”). FIG. 6C is a SEM image of an etched silver foam with silver nanowires immobilized on the surfaces of the foam (referred to as “Foam/nanowires”).

FIG. 7 is a schematic diagram showing a flow electrolyzer used in the comparative experiments described in the Examples section.

FIG. 8 is a bar graph comparing the faradaic efficiency (FE_{co}) values (%) of the electrolysis of CO₂ to CO at an applied current density of 100 mA cm⁻² using three different types of feedstock: an aqueous feedstock saturated with CO₂, bicarbonate feedstocks and gaseous CO₂. The aqueous feedstock saturated with CO₂ was electrolyzed with a zero-gap electrolyzer using a gas diffusion electrode comprising silver nanoparticles as the cathode. The bicarbonate feedstock was electrolyzed with a zero-gap electrolyzer using a metal foam as the cathode. The gaseous CO₂ was electrolyzed with a zero-gap electrolyzer using a gas diffusion electrode comprising silver nanoparticles as the cathode.

FIG. 9A is a graph illustrating the FE_{CO} (%) as a function of current density (mA cm⁻²) for the electrolysis of CO₂ to CO with a zero-gap electrolyzer using each of Foam, Foam/E, Foam/nanowires and gas diffusion electrode control (referred to as “GDE/control”) as the cathode. The temperature of the bicarbonate solution entering the cathode flow plate (the inlet temperature (Tᵢₙₗₑₜ)) is 20° C., and the geometrical surface area of the electrodes is 4 cm². FIG. 9 is a graph illustrating FE_{CO} values as a function of inlet temperature (Tᵢₙₗₑₜ=20, 37, 56 and 70° C.) at an applied current density of 100 mA cm⁻². FIG. 9C is a graph illustrating FE_{CO} (%) at a constant applied current density of 65 mA cm⁻² over the course of an 80 hour experiment in the electrolysis of CO₂ to CO with a zero-gap electrolyzer using either Foam/nanowires or GDE/control as the cathode.

FIG. 10 is a SEM image of the Foam/E electrode.

FIGS. 11A and 11B are SEM images of the Foam/nanowires electrode. FIG. 11A is a SEM image of the Foam/nanowires electrode collected at 200-μm scale.

FIG. 11B is a SEM image of the Foam/nanowires electrode collected at 5-μm scale.

FIGS. 12A and 12B are SEM images of the Foam/nanowires electrode. FIG. 12A is a SEM image of the Foam/nanowires electrode collected at 10-μm scale from a top view of the electrode. FIG. 12B is a SEM image of the Foam/nanowires electrode collected at 200-μm scale from a cross-section view of the electrode.

FIG. 13 are X-ray diffraction (XRD) patterns for each of the Foam, Foam/E and Foam/nanowires electrodes.

FIGS. 14A, 14B, 14C and 14D are graphs depicting cyclic voltammetry measurements by scanning the potential from −0.6 V to −0.4 V (vs. Ag/AgCl) with different scan rates ranging from 10 to 100 mV s⁻¹ recorded for each of the Foam (FIG. 14A), Foam/E (FIG. 14B), Foam/nanowires (FIG. 14C), and GDE/control (FIG. 14D) electrodes. The geometric surface area of all of the tested electrodes is 1 cm². FIG. 14E is a plot of the current density (mA cm⁻²) as a function of scan rates (mV/s) from the FIGS. 14A-14E plots for the calculation of double layer capacitance measurements.

FIG. 15 is a bar graph depicting cell voltages (V_{cell}) obtained from the electrolysis of CO₂ to CO with a zero-gap electrolyzer for each of the GDE/control, Foam, Foam/E, and Foam/nanowires electrodes used as the cathode. The electrolysis was performed at an applied current density of 100 mA cm⁻². Three samples of each electrode were tested, and the data was collected at a sampling time of 500 seconds.

FIG. 16 is a graph depicting the H₂ concentration produced in the cathode electrolyte reservoir from the electrolysis of CO₂ to CO with a zero-gap electrolyzer using Foam/E as the cathode at different inlet temperatures. The electrolysis was performed at an applied current density of 100 mA cm⁻². The sampling time is 500 seconds.

FIG. 17A is a SEM image showing a top view of the Foam/nanowires electrode before and after an electrolysis of CO₂ to CO with a zero-gap electrolyzer over a course of 80 hours. FIG. 17B is a SEM image showing a cross-sectional view of the Foam/nanowires electrode before and after an electrolysis of CO₂ to CO with a zero-gap electrolyzer over a course of 80 hours.

FIGS. 18A and 18B are SEM images of the GDE/control electrode before an electrolysis of CO₂ to CO with a zero-gap electrolyzer over a course of an 80 hour experiment, collected at 500 μm and 100 μm respectively. FIGS. 18C and 18D are SEM images of the GDE/control electrode after an electrolysis of CO₂ to CO with a zero-gap electrolyzer over a course of an 80 hour experiment, collected at 500 μm and 100 μm respectively.

FIG. 19 is a bar graph comparing the faradaic efficiency (FE_{CO}) values (%) of the electrolysis of CO₂ to CO reusing a foam/nanowires electrode as the cathode three weeks after the same electrode has been used in an 80 hour experiment.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

One application of the present invention is in the field of carbon capture. The basic approach may be used to extract atmospheric carbon dioxide using a chemical sorbent to produce bicarbonate (Eq. 1). The bicarbonate may be supplied to an electrochemical cell to yield useful carbon-containing products. In the electrochemical cell, bicarbonate may undergo a chemical reaction at an ion exchange membrane to yield carbon dioxide (Eq. 2). The chemical reaction may occur on an interface of the ion exchange membrane facing a cathode. The carbon dioxide may then participate in a reduction reaction at the cathode to yield useful carbon-containing products (Eq. 3). An example of a carbon-containing product is carbon monoxide. A liquid sorbent by-product may also be formed in the reduction reaction. The liquid sorbent by-product may be a hydroxide solution. The hydroxide solution may supplied to form all or part of the chemical sorbent to react with the atmospheric carbon dioxide for subsequent carbon capture.

CO₂ capture: CO_{2(g)}+2KOH_{(aq)} [symbol] K₂CO_{3(aq)}+H₂O₍ᵢ₎ Eq. 1

Conversion of bicarbonate: H+(aq)+HCO₃₋(aq) [symbol] H₂O(l)+CO₂(g) Eq. 2

Reduction of bicarbonate: CO_{2(g)}+H₂O₍ₗ₎+2e⁻ [symbol] CO_{(g)}+2OH⁻_{(aq)} Eq. 3

A particularly useful electrochemical cell for the electrolysis of bicarbonate incorporates a porous metallic electrode. The porous metallic electrode serves as a cathode. The porosity of the porous metallic electrode may be increased to increase the current efficiency of the electrolysis reaction. In an example embodiment, the porosity of the porous metallic electrode is at least 80%. As demonstrated in the examples provided herein an electrochemical cell comprising a porous metal electrode (such as a silver foam electrode) can provide highly efficient conversion of bicarbonate (which may, for example, be obtained by carbon capture) to other carbon containing compounds.

Examples of operating conditions that are favorable in the electrolytic conversion of bicarbonate include:
bicarbonate solution concentration in the range of from about 3 M to about 6 M;
operating temperature in the range of from about 60° C. to about 80° C.;
operating pressure in the range of from about 4 to about 10 atm.

In example embodiments involving the electrolysis of bicarbonate to carbon monoxide using a porous metallic electrode as the cathode, a faradaic efficiency of at least about 40% at a current density of about 100 mA cm⁻² can be achieved.

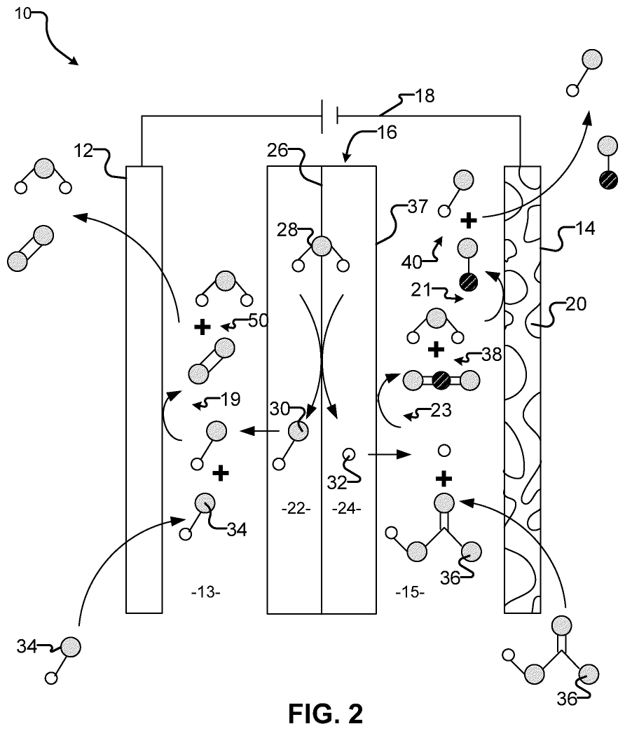

FIG. 2 illustrates an example electrochemical cell 10 that incorporates a porous metallic electrode 14. Electrochemical cell 10 comprises an anode 12 and porous metallic electrode 14. Anode 12 may be exposed to an anode chamber 13. Porous metallic electrode 14 may be exposed to a cathode chamber 15. Anode 12 and porous metallic electrode 14 are separated by an ion exchange membrane 16. Ion exchange membrane 16 may be positioned proximate to porous metallic electrode 14. In some embodiments, ion exchange membrane 16 is pressed against porous metallic electrode 14.

A power source 18 applies a potential difference between anode 12 and porous metallic electrode 14. A positive electrical charge is applied to the anode. A negative electrical charge is applied to the cathode. An oxidation reaction 19 takes place at anode 14. A reduction reaction 21 takes place at porous metallic electrode 14. Power source 18 may be configured to maintain a desired electric current between anode 12 and porous metallic electrode 14 and/or to maintain a potential difference between anode 16 and porous metallic electrode 14 at a desired level or in a desired range.

Porous metallic electrode 14 may be made of any suitable metals. In some embodiments, porous metallic electrode 14 is made of a transition metal, or a combination of one or more transition metals. In some embodiments, porous metallic electrode 14 comprises silver (Ag). In an example embodiment, porous metallic electrode 14 comprising silver is used to selectively convert gaseous carbon dioxide to carbon monoxide. Porous metallic electrodes 14 which comprise other transition metals may result in different reaction products being formed by the reduction reaction.

In some embodiments at least a surface of porous metallic electrode 14 is made of material which has hydrophilic properties. In some embodiments, porous metallic electrode 14 is essentially hydrophilic. In some embodiments, the surfaces of porous metallic electrode 14 is hydrophilic. Hydrophilicity refers to a material's affinity to liquid or vapor water. A hydrophilic surface is a surface that tends to adsorb water or be wetted by water.

A plurality of pores 20 or void spaces is distributed throughout porous metallic electrode 14. In some embodiments, pores 20 are interconnected. An example of a porous material suitable for use as electrode 14 is a metal foam. Other suitable porous materials may be used. For example, porous materials such as mesh and filter may also be used. In an example embodiment, porous metallic electrode 14 comprises a free-standing layer made of a silver foam. Such electrodes may be referred to as “free-standing gas diffusion electrodes”.

Increasing the porosity of porous metallic electrode 14 may correspondingly increase the electrochemically active surface area of electrode 14. An electrochemical active surface area may represent the area of the electrode material that is accessible to the electrolyte that is used for charge transfer and/or storage.

Porous metallic electrode 14 may be modified to increase the electrochemically active surface area of electrode 14 prior to use. Porous metallic electrode 14 may be chemically modified. An example is etching electrode 14. Etching may be performed by immersing electrode 14 into an acid solution. In an example embodiment, porous metallic electrode 14 is etched by immersion in dilute nitric acid (30% v/v HNO₃) for 10 seconds. Another example is depositing nanosized catalysts onto the surfaces of the electrode. Examples of suitable nanosized catalysts include nanowires, nanorods, nanoparticles, nanocubes and the like. This may be done, for example, by airbrushing an ink composed of nanowires solution onto the electrode surfaces. In an example embodiment, surfaces of porous metallic electrode 14 are airbrushed with an ink composed of 200 μL silver nanowires solution dispersed in 2 mL of isopropyl alcohol.

The porosity of porous metallic electrode 14 can be in a range of from 1% to 99%. In some embodiments, the porosity of porous metallic electrode 14 is greater than about 40%. In some embodiments, the porosity of metallic electrode 14 is about 70% to about 85%. The pore size distribution of porous metallic electrode 14 may be homogeneous or heterogeneous. The electrochemically active surface area (ECSA) of porous metallic electrode 14 may be greater than about 0.1 m²/g. In example embodiment, ECSA of porous metallic electrode 14 may be in the range of from about 0.10 m²/g to about 0.3 m²/g.

In some embodiments the thickness of porous metallic electrode 14 is in the range of from about 100 μm to about 300 μm. In some embodiments the density of porous metallic electrode 14 is in the range of from about 0.5 g/cm³ to 2.1 g/cm³.

Anode 12 may comprise any materials suitable for use as an electrode. Such material may comprise a catalyst suitable for driving an oxygen evolution reaction (OER). In some embodiments, anode 12 comprises a gas diffusion electrode. In some embodiments, anode 12 is made of one or more metallic materials. The metallic material may be any transition metal, or combination of one or more transition metals. Anode 12 may comprise a porous material. In an example embodiment, anode 12 comprises a free-standing layer made of a nickel (Ni) foam.

Ion exchange membrane 16 comprises an anion exchange layer 22, a cation exchange layer 24, and an intermediate layer 26 separating layers 22, 24. Anion exchange layer 22 faces anode chamber 13. Cation exchange layer 24 faces cathode chamber 15. Water molecules 28 may diffuse to intermediate layer 26. One source of water molecules 28 may be reaction products formed from the reactions occurring at anode 12 and/or electrode 14 and/or ion exchange membrane 16. Ion exchange membrane 16 is adapted to dissociate water 28 into hydroxide ions 30 and hydrogen ions 32.

Hydroxide ions 30 may permeate through anion exchange layer 22 toward anode 12. Hydroxide ions 30 may participate in oxidation reaction 19 by reacting with a reactant 34 at anode 12 to form a product compound 50. Reactant 34 can be any solvent suitable for use as an anolyte.

Hydrogen ions 32 may permeate through cation exchange layer 24 toward porous metallic electrode 14. Hydrogen ions 32 may participate in a chemical reaction by reacting with a carbon-containing solution 36 containing carbon ions 35. Hydrogen ions 32 may react with carbon ions 35 to form one or more carbon-containing intermediate products 38.

A chemical reaction 23 may be performed on ion exchange membrane 16. In some embodiments, chemical reaction 23 is performed on an interface 37 of ion exchange membrane. Interface 37 may be on a surface facing porous metallic electrode 14. Carbon-containing intermediate product 38 may participate in reduction reaction 21 at porous metallic electrode 14 to produce one or more carbon-containing resulting products 40.

Ion exchange membrane 16 is a bipolar membrane. In an example embodiment, the bipolar membrane 16 is a membrane that is commercially available under the product name Fumasep™.

In an example embodiment, carbon-containing solution 36 comprises bicarbonate (HCO₃⁻). Bicarbonate reacts with hydrogen ions 32 at ion exchange membrane 16 to form carbon-containing intermediate products 38. In some embodiments, carbon-containing intermediate products 38 comprise gaseous carbon dioxide. Gaseous carbon dioxide may then participate in reduction reaction 21 at porous metallic electrode 14 to produce one or more carbon-containing resulting products 40. In some embodiments, carbon-containing resulting products 40 comprise carbon monoxide.

In some embodiments, the concentration of carbon-containing solution 36 being supplied to the porous metallic electrode 14 for reaction with hydrogen ions 32 is in the range of about 0.1 to about 6 M. In some embodiments, the concentration of carbon-containing solution 36 is in the range of from about 3 M to about 6 M.

In some embodiments, the electrolysis is operated at a temperature in the range of from 0 to about 80° C. In some embodiments, the electrolysis is operated at a temperature in the range of from about 60° C. to about 80° C.

In some embodiments, carbon-containing solution 36 is heated to a temperature before participating in chemical reaction 23. In some embodiments, carbon-containing solution 36 is heated to a temperature in the range of from about 60° C. to about 80° C. In some embodiments, carbon-containing solution 36 is heated to a temperature of about 70° C. Carbon-containing solution 36 may be heated to a temperature higher than the operating temperature maintained within the electrochemical cell. The selective heating of the bicarbonate solution may increase the efficiency of the electrochemical reaction.

In some embodiments, the electrolysis is operated at an operating pressure in the range of from about 1 atm to about 10 atm. In some embodiments, the operating pressure is in the range of from about 4 atm to about 10 atm.

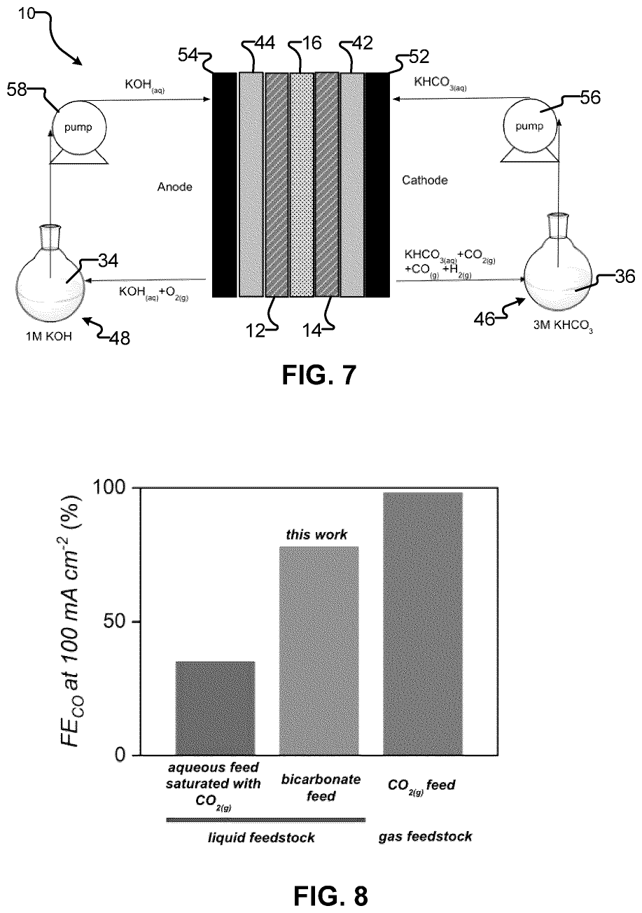

In some embodiments, electrochemical cell 10 comprises a flow cell (as shown in FIG. 7). In such embodiments, a cathode flow plate 42 is pressed against porous metallic electrode 14. An anode flow plate 44 may be pressed against anode 12. An inlet of cathode flow plate 42 may be fluidly connected to a catholyte reservoir 46. Catholyte reservoir 46 contains carbon-containing solution 36. Carbon-containing solution 36 may be delivered to porous metallic electrode 14 by flowing through the inlet of cathode flow plate 42. An outlet of cathode flow plate 42 may also be fluidly connected to an electrolyte drain (not shown). Carbon-containing resulting products 40 may flow out of cell 10 through the outlet of cathode flow plate 42.

An inlet of anode flow plate 44 may be fluidly connected to an anolyte reservoir 48. Anolyte reservoir 48 contains reactant 34. Reactant 34 may be delivered to anode 12 by flowing through the inlet of anolyte flow plate 44. An outlet of anode flow plate 44 may be fluidly connected to an electrolyte drain (not shown). Product compounds 50 formed from oxidation reaction 19 may flow out of cell 10 through the outlet of anode flow plate 44.

Housings 52, 54 may be arranged to press against cathode 42 and 44 anode flow plates respectively.

In some embodiments, a catholyte pump 56 is arranged to deliver carbon-containing solution 36 to porous metallic electrode 14. Catholyte pump 56 may deliver carbon-containing solution 36 through cathode flow plate 42. An anolyte pump 58 may be arranged to deliver reactant 34 to anode 12. Anolyte pump 58 may deliver reactant 34 through anode flow plate 44. One or more flow meters (not shown) may be provided to monitor the flow rates at which carbon-containing solution 36 and reactant 34 are delivered to porous metallic electrode 14 and anode 12 respectively. Electrolyte pumps 56, 58 may be communicatively connected to the flow meter(s) to maintain a desired flow rate at which reactant 34 and carbon-containing compound 36 are delivered to the electrodes.

In some embodiments, the flow rate at which carbon-containing solution 36 is delivered to porous metallic electrode 14 is in the range of from about 10 mL min⁻¹ to about 100 mL min⁻¹ for a porous metallic electrode having a geometric surface area of 4 cm². The flow rate may be scaled according to the area of the electrode. In some embodiments, the flow rate at which carbon-containing solution 36 is delivered to porous metallic electrode 14 is in the range of from about 70 mL min⁻¹ to about 100 mL min⁻¹ for a porous metallic electrode having a geometric surface area of 4 cm². The flow rate may be maintained constant throughout the duration of the electrolysis.

An aspect of the invention relates to apparatuses and methods of electrolyzing bicarbonate to yield useful carbon-containing products with high faradaic efficiency. In some embodiments, the faradaic efficiency of the reduction reaction is greater than about 40%. The high faradaic efficiency may be achieved with relatively low current density. The current density may, for example, be in the range of from about 50 mA cm⁻² to about 500 mA cm⁻². In example embodiments, a faradaic efficiency of greater than about 40% may be achieved with an applied current density of about 100 mA cm⁻². In some embodiments, the electrical potential applied across the anode and the porous metallic electrode introduces a current density about 50 mA cm⁻² to about 1000 mA cm⁻².

The faradaic efficiency may remain substantially constant over a long electrolysis time. In an example embodiment, the faradaic efficiency is maintained with less than about 3% reduction over a long electrolysis time. Such electrolysis time may be at least 80 hours.

In some embodiments, anode 12 and porous metallic electrode 14 are compressed on opposing sides of ion exchange membrane 16. In such electrochemical cell designs, the inter-electrode gap between the electrodes is equal to the thickness of ion exchange membrane 16. Such a design is known as a “zero-gap” electrolyzer. Embodiments of this invention are not limited to a zero-gap electrolyzer. Other designs of electrochemical cells are also within the scope of the invention. Another example cell construction provides an electrochemical cell comprising an anode and a cathode separated by an anolyte chamber and a catholyte chamber.

An aspect of the invention relates to methods of using a porous metallic electrode to electrolytically reduce a carbon-containing solution to yield carbon-containing compounds. The methods may apply a cell of the general type described above.

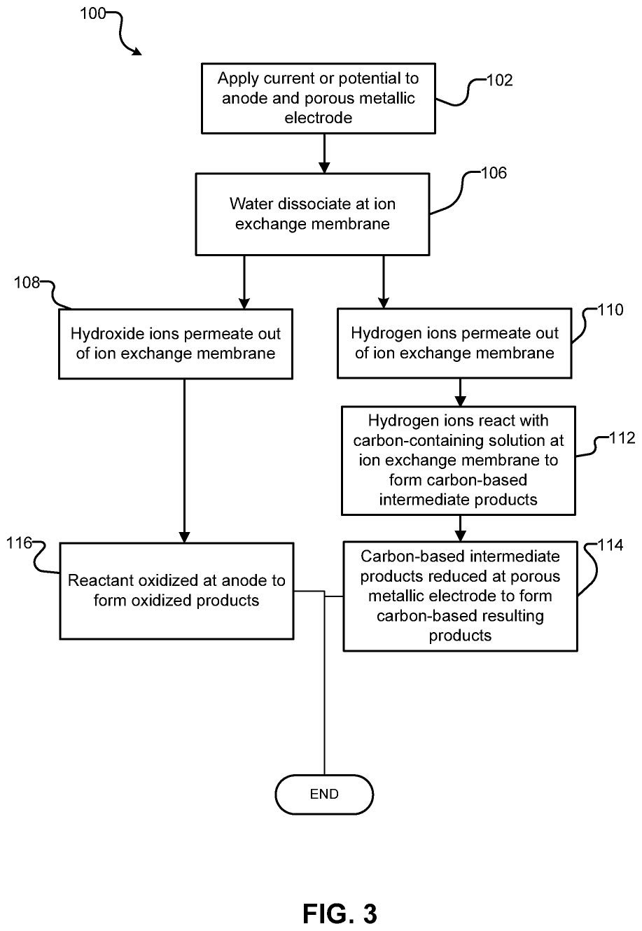

FIG. 3 is a flow chart showing steps in an example electrochemical method 100. In block 102, an electrical current and/or potential is applied between an anode and a porous metallic electrode which acts a cathode. In block 106, water is dissociated into hydroxide ions and hydrogen ions within an ion exchange membrane (e.g. a bipolar membrane). This results in the permeation of hydroxide ions toward the anode (block 108), and the permeation of hydrogen ions toward the porous metallic electrode (block 110). In block 112, carbon-containing solution 36 reacts with the permeated hydrogen ions at the ion exchange membrane to form one or more carbon-containing intermediate products. In block 114, one of the carbon-containing intermediate products are reduced at the porous metallic electrode to form one or more carbon-containing resulting products. In block 116, a reactant is oxidized to form one or more oxidized products at the anode. The oxidation reaction at block 116 is performed simultaneously with the reduction reaction at block 114.

In an example embodiment, the carbon-containing solution is a solution containing bicarbonate. In some such embodiment, the one or more carbon-containing intermediate products comprise gaseous carbon dioxide. The one or more carbon-containing resulting products may comprise carbon monoxide.

Electrochemical method 100 may be tuned to optimize one or more of product selectivity, current efficiency and reaction rate of each of the electrolysis reaction by adjusting one or more of:
the properties of the porous metallic electrode and/or the anode such as the particular metal or metals used and/or its surface area, density and thickness, and/or
concentrations of the reactant and/or carbon-containing solution, and/or
temperature, and/or
pressure, and/or
flow rates of the reactant and/or carbon-containing solution; and/or
the applied current, and/or
the applied electrical potential, and/or
any combination of two or more of the above.

Adjusting the properties of the porous metallic electrode and the operating pressure of electrochemical method 100 alone or in combination may achieve the desired product selectivity and/or current efficiency of the reaction.

An aspect of the invention relates to combining electrochemical method 100 with an upstream carbon capture process to convert CO₂ from a point source (e.g. flue gas) or the atmosphere to useful carbon-containing products. A carbon capture process involves trapping gaseous carbon dioxide. The gaseous carbon dioxide may be captured directly from the atmosphere. Alternatively the gaseous carbon dioxide may be captured at point sources. For example, gaseous carbon dioxide may be captured from an industrial process that generates significant carbon dioxide emissions.

Conventional carbon capture processes process bicarbonate to CO₂ using high temperature and pressurization steps which consume significant amounts of energy. One way to avoid the high temperature calcination and pressurization steps is to directly electrolyze a solution containing bicarbonate to yield carbon-based products.

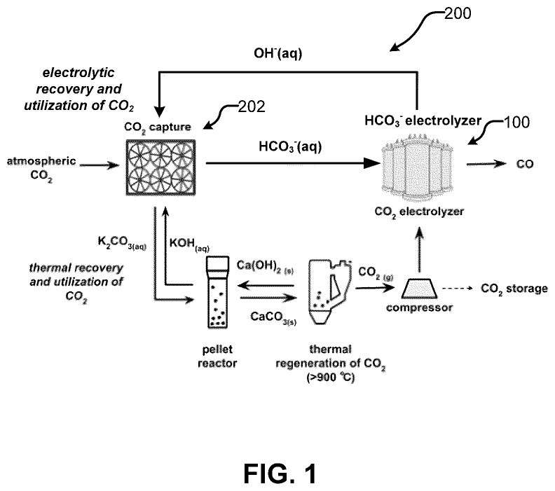

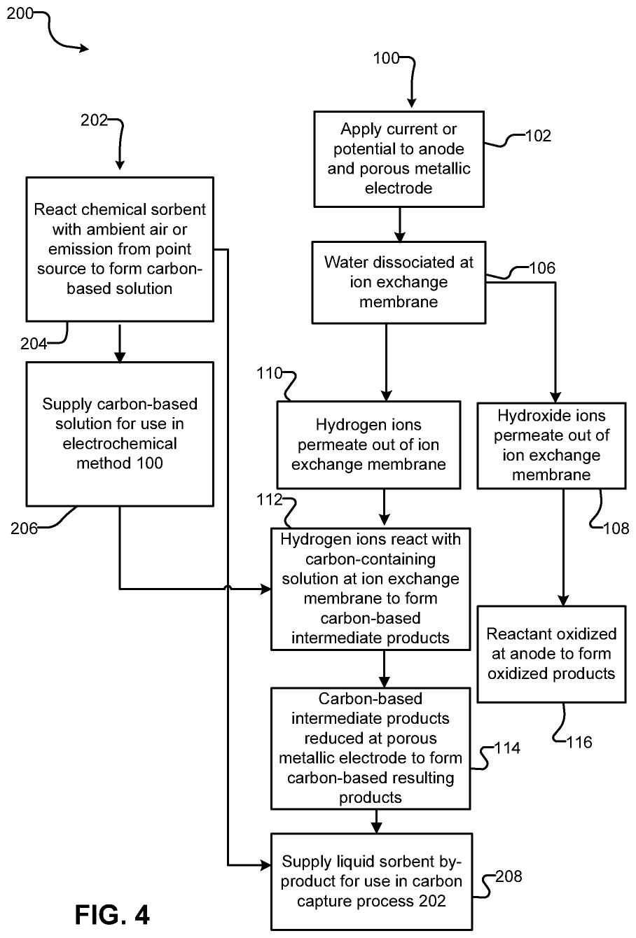

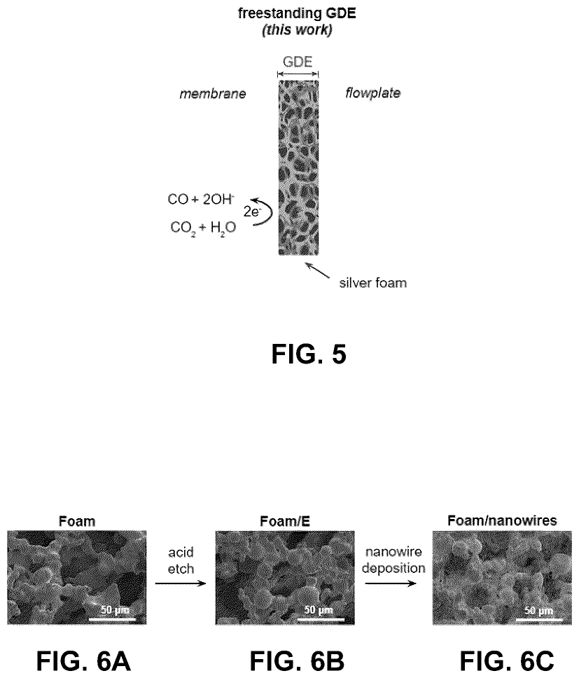

FIG. 4 is a flow chart showing steps in a method 200 of capturing carbon dioxide. Method 200 bypasses the high temperature calcination and pressurization steps, as shown in FIG. 1. Method 200 comprises pairing a carbon capture process 202 with electrochemical method 100. Carbon capture process 202 may be arranged upstream of electrochemical method 100. In some embodiments, carbon capture process 202 involves reacting a chemical sorbent with the ambient air or emissions from a point source (block 204). Block 204 may, for example comprise bringing the carbon dioxide into contact with the chemical sorbent in a chamber or gas-liquid contactor.

In an example embodiment, the chemical sorbent is a basic solution. The basic solution may comprise hydroxide. In some embodiments, the hydroxide solution reacts with gaseous carbon dioxide to form solution comprising bicarbonate. In such embodiments, the chemical reaction between potassium hydroxide solution and gaseous carbon dioxide is shown as follows:

CO_{2(g)}+2KOH_{(aq)} [symbol] K₂CO_{3(aq)}+H₂O₍ₗ₎

The solution comprising bicarbonate formed in carbon capture process 202 may be supplied for use in electrochemical method 100 (block 206). The solution comprising bicarbonate may be supplied to form part of or all of carbon-containing solution 36.

In some embodiments, electrochemical reduction of the carbon-containing intermediate product at the porous metallic electrode forms one or more carbon-containing resulting products and optionally a liquid sorbent by-product 210 (at block 114). In some embodiments, liquid sorbent by-product 210 is a hydroxide solution. The hydroxide solution may be supplied for use in carbon capture process 202 (block 208). The hydroxide solution may form part of or all of chemical sorbent 204.

The resulting products may be separated from the bicarbonate solution. For example, the resulting products may comprise one or more gases and the resulting products may be separated from the bicarbonate solution by a gas liquid separation.

In some embodiments a depleted bicarbonate solution that has been processed by the electrochemical method is recycled through the electrochemical method to process more of the bicarbonate and/or returned to carbon capture process 202 for use as the chemical sorbent. In some embodiments some of liquid sorbent by-product 210 is mixed with the depleted bicarbonate solution.

In summary, one example aspect of the invention provides an electrode for electrolysis of liquid carbon containing feedstock, the electrode comprising:
(a) a free-standing current collector having a plurality of interconnected pores disposed therein, wherein said current collector may comprise a porous metallic material.
   a. wherein said porous metallic material may comprise a porous metallic foam.
   b. wherein said porous metallic foam may comprise at least one transition metal.
   c. wherein said porous metallic foam may be a porous silver foam.
   d. wherein said free-standing current collector may be a porous silver foam electrode, or Foam electrode.
   e. wherein said free-standing current collector may be an etched silver foam electrode, or Foam/E electrode.
   f. wherein said free-standing current collector may be an electrode comprising an etched silver foam coated with silver nanowires, or Foam/nanowires electrode

Another example aspect of the invention provides a method of making an etched free-standing porous metallic foam electrode, said method comprising providing a porous metallic foam and treating it with acid.
(a) wherein said acid may be nitric acid.
(b) wherein said porous metallic foam may comprise silver. For example, wherein said produced etched free-standing porous metallic foam electrode may be an etched silver foam electrode, or Foam/E electrode.

Another example aspect of the invention provides a method of making a metallic nanowires free-standing porous metallic foam electrode, the method comprising:
(a) providing a porous metallic foam;
(b) treating said porous metallic foam with acid, thereby etching it;
(c) and applying metallic nanowires to said etched porous metallic foam from step (ii), producing a metallic nanowires porous metallic foam electrode.
   a. Wherein said metallic foam may comprise silver.
   b. Wherein said acid may comprise nitric acid.
   c. Wherein said metallic nanowires in step (iii) may be provided as a metallic nanowire solution. For example, wherein said metallic nanowire solution may comprise silver nanowires sonicated in isopropyl alcohol and may be applied to an etched silver foam by spray coating, producing an etched free-standing porous silver foam electrode coated with silver nanowires, or Foam/nanowires electrode.

Another example aspect of the invention provides a method for processing a solution of bicarbonate to yield one or more carbon compounds, said method comprising:
(a) supplying an aqueous solution comprising bicarbonate at a free-standing porous metallic cathode of an electrochemical reactor that is further comprising an anode, wherein said free-standing porous metallic cathode and said anode are separated by a bipolar membrane;
(b) applying a potential difference between said free-standing porous metallic cathode and said anode to cause an electrochemical reaction yielding product gas comprising one or both of gaseous carbon dioxide and gaseous carbon monoxide; and
(c) separating said product gas from said aqueous solution.
   a. Wherein said free-standing porous metallic cathode may comprise a metallic foam.
   b. Wherein said metallic foam may comprise silver.

Another example aspect of the invention provides a method for processing a solution of bicarbonate to yield one or more carbon compounds, said method comprising:
(a) supplying an aqueous solutions comprising bicarbonate at a free-standing porous metallic foam cathode of an electrochemical reactor that is further comprising an anode, wherein said free-standing porous metallic foam cathode and said anode are separated by a bipolar membrane;
(b) applying a potential difference between said free-standing porous metallic foam cathode and said anode to cause an electrochemical reaction yielding product gas comprising one or both of gaseous carbon dioxide and gaseous carbon monoxide; and
(c) separating said product gas from said aqueous solution.
   a. Wherein said free-standing porous metallic foam cathode may comprise a transition metal.
   b. Wherein said free-standing porous metallic foam cathode may comprise silver and/or gold.
   c. Wherein said free-standing porous metallic foam cathode may be a silver metallic foam electrode (Foam), an etched silver foam electrode (Foam/E), or an electrode comprising an etched silver foam coated with silver nanowires (Foam/nanowires).

The invention is further described with reference to the following specific examples, which are not meant to limit the invention, but rather to further illustrate it.

### EXAMPLES

An electrochemical cell of the type illustrated in FIG. 1 and the method of performing electrolysis illustrated in FIGS. 2 and 7 were used to convert liquid bicarbonate (KHCO₃) to gaseous carbon dioxide (CO_{2(g)}) at ion exchange membrane 16, and to convert CO₂ to gaseous carbon monoxide (CO_{(g)}) at metallic gas electrode 14. In the example embodiment, metallic gas electrode 14 comprises a free-standing silver foam. Anode 12 comprises a free-standing nickel foam. The anolyte electrolyte used in the example embodiment is potassium hydroxide (KOH).

### Example 1: Porous Free-Standing Silver Foam Electrodes

Bicarbonate electrolysis experiments were designed to test three different modifications of metallic gas electrode 14 which serves as the cathode: (i) silver foam (referred to hereinafter as “Foam”) as shown in FIG. 6A; (ii) etched silver foam (referred to hereinafter as “Foam/E”) as shown in FIG. 6B; and (iii) etched silver foam coated with silver nanowires (referred to hereinafter as “Foam/nanowires”) as shown in FIG. 6C.

Metallic gas electrode 14 (Foam, Foam/E, and Foam/nanowires) which serves as a cathode in the bicarbonate electrolysis experiments were tested against a gas diffusion electrode control (referred to hereinafter as “GDE/control”) which serves as the cathode.

The Foam samples (2 cm×2 cm×200 μm) were prepared by washing commercially available silver foams with deionized (DI) water and isopropanol (IPA). The Foam/E electrodes were prepared by etching Foam in dilute nitric acid (30% v/v HNO₃) for 10 seconds. The Foam/nanowires electrodes were prepared by airbrushing an ink composed of 200 μL silver nanowires solution (dispersed in 2 ml of isopropyl alcohol) onto each side of the Foam/E electrode.

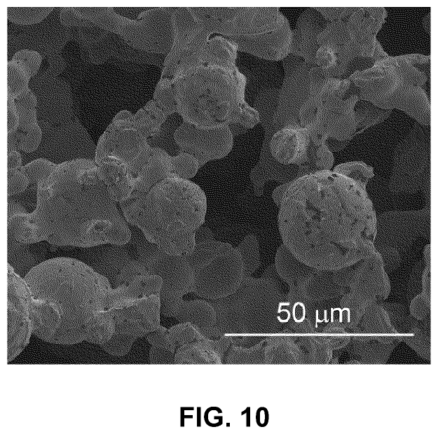

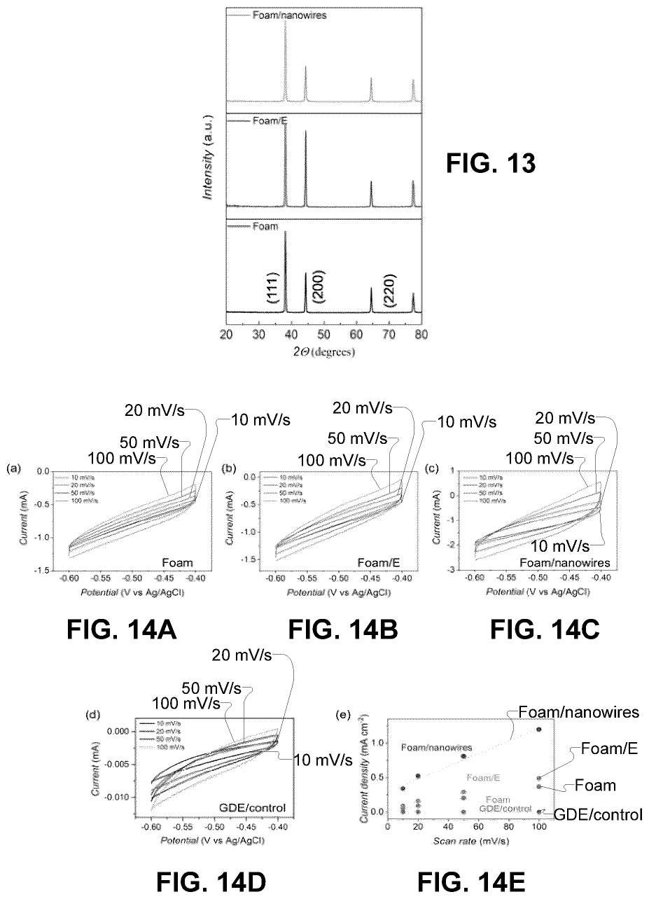

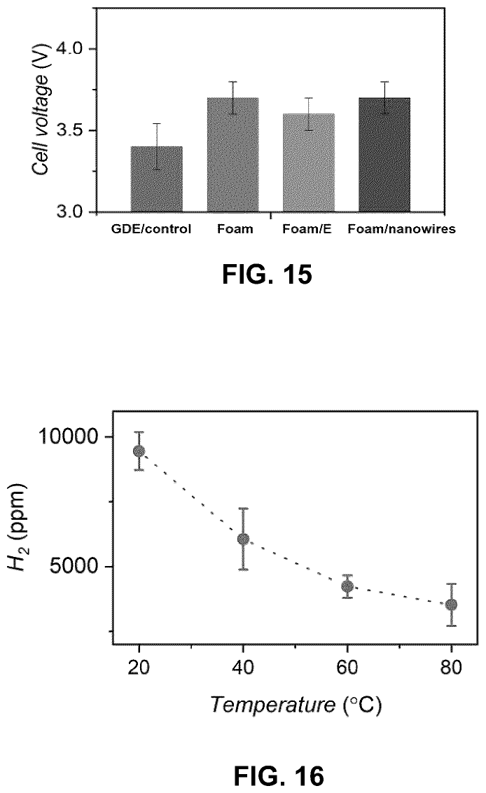

Scanning electron microscopy (SEM) imaging of the porous Foam showed that the silver foam skeletal structure consists of a smooth surface with few cracks and holes (see FIG. 6A). The etched surface of Foam/E contains a high number of cracks and holes (see FIGS. 6B and 10). The silver nanowires with diameters of ˜70 nm were immobilized on the walls of the pores of the silver foam for the Foam/nanowires electrode (see FIGS. 6C, 11A, 11B, 12A and 12B). The nanowires were observed from the surface to a depth of 60-100 μm on each side of the foam. The X-ray diffraction (XRD) measurements of each electrode indicated signals at 38°, 44° and 64° corresponding to metallic silver (111), (200) a nd (220) facets, respectively (see FIG. 13). These reflections are consistent with metallic silver (Ag⁰) being the main constituent of the samples.

The electrochemical surface areas (ECSA) of the Foam, Foam/E, Foam/nanowires and GDE/control were estimated from double-layer capacitance (C_{dl}) measurements (FIG. 14A-14D). The ECSAs of metallic gas electrode 14 were significantly higher than that of the GDE/control. Etching the Foam to form Foam/E increased the ECSA by ˜1.2-fold. The addition of nanowires to the surfaces of the etches form to form Foam/nanowires exhibited a 2.6-fold increase in ECSA. The three different silver foam electrodes were tested in a flow reactor under constant applied current densities of 100, 200 and 300 mA cm⁻².

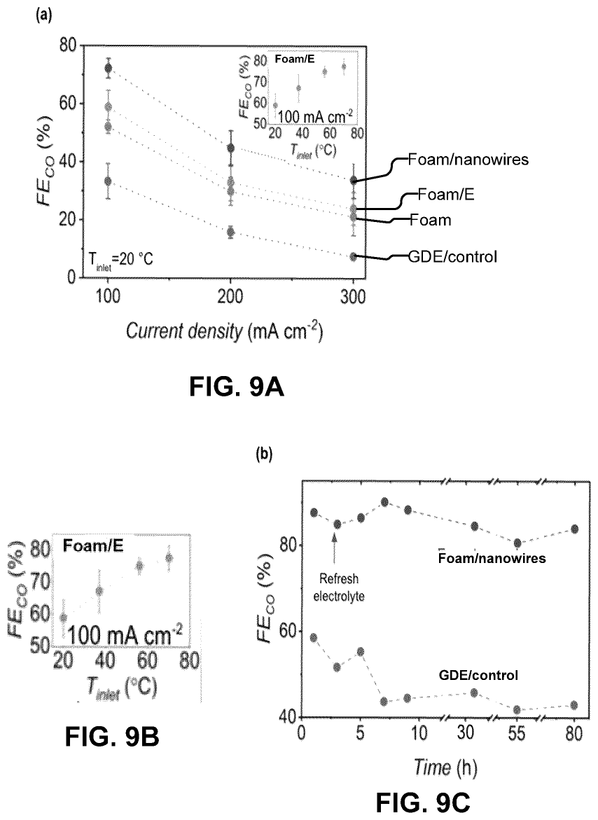

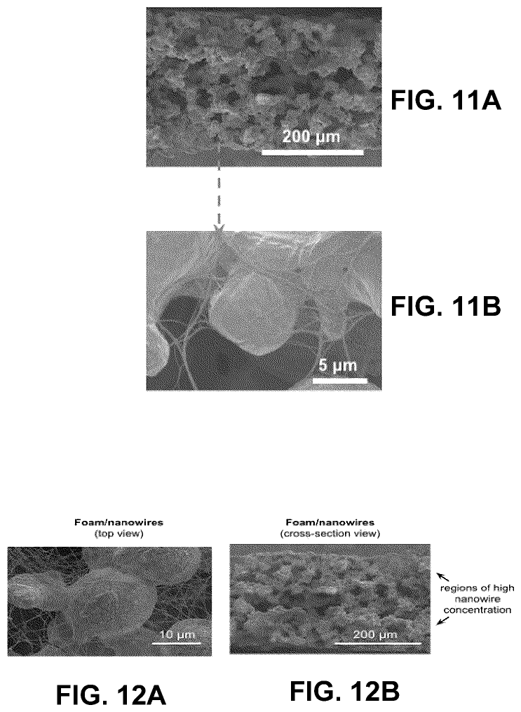

The GDE/control comprises a CeTech® woven carbon cloth support containing a layer of silver nanoparticles. The GDE/control contains an MPL and PTFE common to gas-fed electrolyzers. Electrolysis experiments using the GDE/control at the applied current density of 100 mA cm⁻² for 500 seconds yielded a FE_{CO} value of 33±6%. This benchmark was exceeded by the Foam, which achieved a FE_{CO} value of 52±2%. This difference in FE_{CO} was maintained over 100-300 mA cm⁻² range (see FIG. FIG. 9A). At 100 mA cm⁻², the cell voltage (V_{cell}) of the Foam (3.7±0.1 V) was slightly higher than that of GDE/control (3.4±0.1 V, FIG. 11). The higher V_{cell} may be attributed to relatively larger volumes of the solution being retained within the pores of Foam imposing a larger ohmic drop.

The FE_{CO} was further increased by the higher ECSA Foam/E to 59±6% at 100 mA cm⁻² while maintaining a similar V_{cell} (3.6±0.1 V) to Foam. The addition of the silver nanowires to the Foam/E increased the FE_{CO} value further to 72±3% at 100 mA cm⁻² (3.7±0.1 V; FIG. 9A). These trends in FE_{CO} track the increase in ECSAs for the three electrodes.

### Example 2: Temperature Dependency

The efficiency of bicarbonate electrolysis may be improved by increasing the temperature of the electrolyte to 70° C. (see FIG. 9A). For experiments using the Foam/E electrodes as the cathode, an electrolyte temperature at the flow cell inlet of 70° C. yielded a FE_{CO} of 78±4% at 100 mA cm⁻² with a corresponding voltage of 3.5±0.1 V (c.f. FE_{CO} of 59±6% at 20° C.). The higher performance at elevated temperatures is consistent with the temperature-dependent equilibrium expressed as H⁺_{(ac)}+HCO₃_{^{−}}_{(ac)} [symbol] H₂O₍ₗ₎+CO_{2(g)}, which shifts towards electrocatalytically active CO₂. In addition to more CO₂ being extracted from solution, an increase in OH⁻ may be expected, which may suppress HER and increase CO₂RR (see FIG. 16).

### Example 3: Stability Studies

Stability studies were performed by electrolysing 3.0 M bicarbonate over the course of an 80 hour experiment at an applied current density of 65 mA cm⁻² using a flow cell containing the Foam/nanowires or the GDE/control electrode as the cathode (FIG. 9B). A current density 65 mA cm⁻² was applied instead of 100 mA cm⁻² in an attempt to minimize the effect of the consumption of bicarbonate on electrolysis. Bicarbonate concentrations were held constant by manually refreshing the 3.0 M KHCO₃ electrolyte 500 seconds before each GC measurement.

The FE_{CO} decreased by merely 3% over the course of the 80 hour period in the electrolysis experiment performed using the Foam/nanowires electrode. The GDE/control exhibited a much larger decrease of 16% over the same time period.

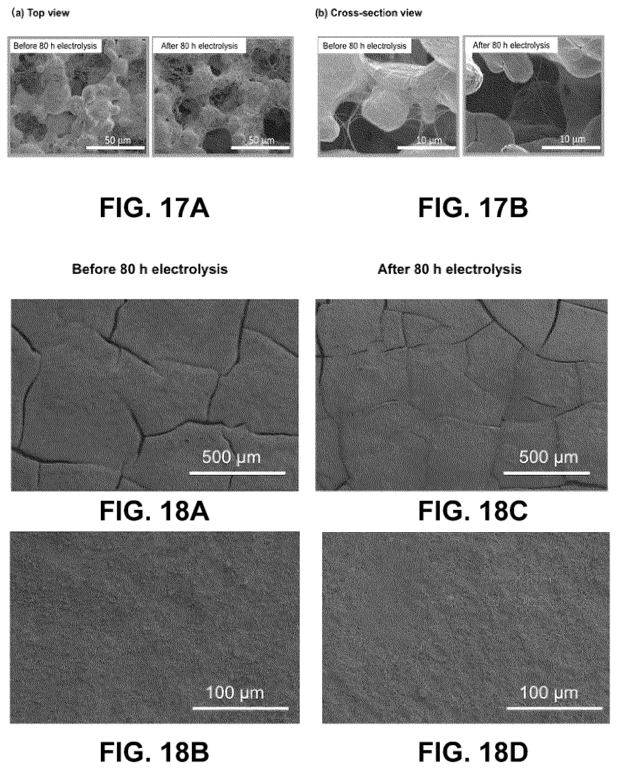

SEM imaging of the Foam/nanowires electrode showed that the silver nanowires on the top of the silver foam surface remained intact after the 80 hour experiment (see FIGS. 17A and 17B). The morphology of the silver nanoparticle catalyst layer in the GDE/control electrode underwent much more dramatic morphological changes to yield a smoother surface after 80 hours of electrolysis (see FIGS. 18A-18D). The much higher operational stability of the Foam/nanowires electrode is consistent with the nominal changes in morphology and the nominal mass loss as shown in Table 1.

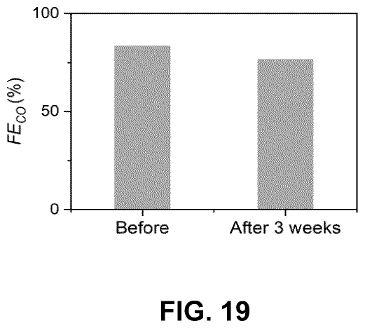

The same Foam/nanowires electrode used for the 80 h electrolysis experiment may be reused 3 weeks later without any regeneration steps to yield nearly the same performance (see FIG. 19). Referring to Table 1, these results demonstrate that a free-standing silver foam electrode does not suffer from silver nanoparticle detachment issues common to conventional GDEs, such as the GDE/control electrode used in these experiments.

TABLE 1
Mass change of the GDE/control and Foam electrodes
after electrolysis over the course of a 50 hour experiment
at an applied current density of 100 mA cm⁻².

| | Before 50 h | After 50 h | Mass |
|---|---|---|---|
| | electrolysis | electrolysis | loss |
| Electrode | (mg) | (mg) | (%) |
| GDE/control | 100.3 | 95.6 | 4.7% |
| Foam | 281.5 | 282.6 | 0% |

### Example 4: Comparison with Conventional GDEs

The results of the experiments show that the free-standing silver foam electrodes provide several advantages over conventional GDEs. Free-standing electrodes simplify the assembly of flow cells relative to conventional GDEs (which require a multi-step fabrication process). Metallic electrodes also mediate remarkably effective bicarbonate electrolysis (e.g., a faradaic efficiency for CO production (FE_{CO}) of 72% at 100 mA cm⁻² at 20° C.). The silver foam electrode also demonstrated no mass loss after 50 h of sustained electrolysis. By contrast, conventional GDE (i.e., multilayer structure of a catalyst layer juxtaposed to a GDL as a support) suffered 5% mass loss over the same period (see Table 1).

The silver foam could be modified by etching and then coating with silver nanowires to render even higher catalytic activity. A FE_{CO} value of 78% at 100 mA cm⁻² was achieved at elevated electrolyte temperatures (˜70° C.) using a modified free-standing electrodes. This is the highest FE_{CO} reported for any liquid-fed zero-gap CO₂RR electrolyzer.

The results show that the use of free-standing porous silver electrodes yield electrolysis performance parameters (e.g., a faradaic efficiency for CO production, FE_{CO}, of 78% at 100 mA cm²; <3% performance loss after 80 h operation) that were superior to conventional carbon-based gas diffusion electrodes (GDEs) designed for gaseous CO₂ fed electrolyzers. These performance metrics compared favorably to any electrolytic flow reactor fed directly with a CO₂ feedstock, with the added benefit of not requiring an energy-intensive pressurization step that would be required for the electrolysis of gaseous CO₂ (see FIG. 8, Table 2).

The use of a free-standing metallic cathodic GDE to electrolyze liquid bicarbonate solutions into a single carbon-based product showed more effective electrolysis than any known CO₂ electrolyzer that uses an aqueous feedstock saturated with CO₂, and nearly as effective as electrolyzers that rely on gaseous CO₂ feedstocks.

As shown in the results, the electrolytic performance of the metallic foam was further improved by increasing the ECSA (e.g., by means of etching, coating with nanowires), and/or by operating at higher temperatures.

In summary, the results of the experiments showed that the free-standing metallic foam electrodes is: (i) more stable than the conventional GDEs, which suffer from catalyst detachment; (ii) easier to assemble; and (iii) reusable without further regeneration steps.

TABLE 2
Overview of reported catalyst performance for CO₂ reduction.

| Cathode Catalyst | FE_{CO} (%) | Cathode feed | Reference |
|---|---|---|---|
| Foam/nanowires | 77% at 100 | 3M KHCO₃ | This work |
| Foam/E | mA cm⁻²; | | |
| | 45% at 200 | | |
| | mA cm⁻²; | | |
| | 34% at 300 | | |
| | mA cm⁻² | | |
| Ag | 98% at 100 | Gaseous CO₂ | 20 |
| nanoparticles/GDL | mA cm⁻² | | |
| Ag | 60% at 50 | 0.5M KHCO₃ | 24 |
| nanoparticles/GDL | mA cm⁻² | saturated with | |
| | | CO₂ | |
| CoPC/GDL | 88% at 200 | Gaseous CO₂ | 21 |
| | mA cm⁻² | | |
| MWNT/PyPBI/Au | 63% at 319 | Gaseous CO₂ | 22 |
| | mA cm⁻² | | |
| Ag | 18% at 104 | 1.25M KHCO₃ | 23 |
| nanoparticles/GDL | mA cm⁻² | | |
| Ag GDE (Silfon, | 10% at 225 | 0.5M K₂SO₄ | 26 |
| Gaskatel) | mA cm⁻² | saturated with | |
| | | CO₂ | |
| Unsupported Ag | 82% at 20 | 0.5M KHCO₃ | 25 |
| particles | mA cm⁻² | saturated with | |
| | | CO₂ | |
| Ag | 37% at 100 | 3M KHCO₃ | 11 |
| nanoparticles/GDL | mA cm⁻² | | |

### Materials

KHCO₃ (99%, Alfa Aesar, USA), silver nanopowder (˜100 nm, 99%, Sigma Aldrich, USA) and ethylenediaminetetraacetic acid, EDTA (99%, Sigma Aldrich, USA) were purchased and used as received. Carbon cloth GDLs (CeTech® with microporous layer) and Fumasep FBM bipolar membranes were purchased from Fuel Cell Store (USA). The membrane was stored in 1 M NaCl prior to use. Silver foams were obtained from Jiangsu Green Materials Hi-Tech. Co. Ltd. (China). Silver nanowires (dispersed in IPA, diameter 70 nm, length 100-200 μm) were obtained from ACS Materials. Nickel foams (>99.99%) were purchased from MTI Corporation (USA) and Nafion® 117 solutions (5 wt %; in a mixture of lower aliphatic alcohols and water were obtained from Sigma Aldrich, USA. Nitric acid (70 wt %, Fisher Scientific, USA) was used to make 25% v/v etching solutions.

### Instrumentation

A CH instrument 660D potentiostat (USA) equipped with an Amp booster was used for all electrolysis experiments. A Ag/AgCl (3 M NaCl) reference electrode (BASi®) was used for electrochemical surface area measurement. A gas chromatography instrument (GC, Perkin Elmer, Clarus 580), equipped with a packed MolSieve 5 Å column and a packed HayeSepD column was used to detect CO and H₂ using a flame ionization detector (FID) and a thermal conductivity detector (TCD), respectively. Argon (99.999%, Praxair Canada Inc.) was the carrier gas. The concentrations of the products CO and H₂ (ppm) in the headspace of the catholyte reservoir were quantified using previously constructed calibration lines for CO and H₂. The spray-coater (Power Fist, China) equipped with a 0.22 mm nozzle and 2 ml paint cup was used for deposition of catalyst inks on the GDLs.

Scanning electron microscopy (SEM) was performed using a FEI Helios NanoLab 650 dual beam scanning electron microscope with an accelerating voltage of 5.0 keV and a beam current of 50 pA. The X-ray diffraction (XRD) data were obtained with a Bruker D8 Advance diffractometer using Cu K-alpha radiation. Data was collected between 2θ angles of 20° to 80° at a rate of 6° per minute.

### Methods

Cathode preparation. The silver foam and nickel foam were cut into desired dimensions with a blade and washed with acetone and water. The silver foam (0.085 g cm⁻²) was treated with dilute nitric acid solution (25% v/v HNO₃) in a 50 ml beaker for 10 s to remove the oxide layer and increase its electrochemical surface area. The etched silver foam (0.070 g cm⁻²) was further washed thoroughly with deionized (DI) water, followed by a rinse with 3 M KHCO₃. 200 μl silver nanowires solution was dispersed in 2.0 ml isopropyl alcohol (IPA) by sonication and was then hand-sprayed onto the etched silver foam substrate (silver nanowire loading: 5.90±0.46 mg). The prepared electrode was stored in DI water for further use. To fabricate traditional GDEs with silver nanoparticles (GDE/control), a catalyst ink was prepared by mixing 315 mg silver nanoparticles, 15 ml DI water, 15 ml IPA and 420 μl Nafion® 117 solution. The catalyst ink was then spray-coated on the carbon cloth to make multiple GDEs, and each GDE (geometric area: 4 cm²) has silver loadings of 3.7±0.1 mg cm⁻².

Two-electrode flow cell. The experiments were conducted in a two-electrode flow cell as illustrated in FIG. 2. The membrane electrode assembly (MEA) consisted of a fully hydrated Fumasep bipolar membrane (BPM) sandwiched between the anode (Ni foam) and the cathode (conventional GDEs or silver foam based electrodes). A peristaltic pump delivered 1.0 M KOH to the anode at a constant flow rate of 40 ml min⁻¹. The 3.0 M KHCO₃ cathode electrolyte was delivered separately at a constant flow rate of 50 ml min⁻¹. The headspace of the cathode electrolyte reservoir was purged with N₂ at 160 sccm over the course of each experiment. Product gases and N₂ in the headspace of the cathode electrolyte reservoir were delivered to an in-line gas chromatograph (GC) with data analysis and peak integration completed in PeakSimple software. The temperature of the catholyte reservoir was controlled with a water bath set to 20, 40, 60, or 80° C.

Controlled temperature experiments. The catholyte reservoir was placed in a water bath with increased temperatures (T_{bath}) and was allowed to reach thermal equilibrium before electrolysis. The temperature of the catholyte entering the flow cell was measured right at the inlet of the cathode flow plate (Tᵢₙₗₑₜ), since some heat losses were expected during the transfer of liquid from the reservoir to the flow cell.

Electrochemical surface area (ECSA) measurements. Cyclic voltammetry (CV) of the Foam, Foam/E, Foam/nanowires and GDE/control was performed from −0.6 V to −0.4 V (vs. Ag/AgCl) in 3 M KHCO₃ solution at different scan rates ranging from 10 to 100 mV s⁻¹. All electrodes had the geometric area of 1 cm². ECSA of silver was calculated as C_{dl}/C_{S}, where C_{dl} represents double layer capacitance and C_{S} represents the standard capacitance of a smooth planar surface silver in an aqueous electrolyte. Values of C_{dl} were calculated based on the following equation: i=vC_{dl}, and the current densities were obtained at −0.5 V vs Ag/AgCl. The current density (i) was plotted as a function of scan rates (v), and then the slope represents C_{dl}. C_{S} was considered constant for all silver electrodes. Therefore, the C_{dl} has a direct proportional relationship with ECSA and relative ECSA of different foam electrodes was found using this method. The C_{dl} measurement for GDE/control may include contributions from GDL, however, with the potential extra C_{dl} measured, the calculated silver ECSA of GDE/control is still significantly lower.

Measuring cathode mass losses. The stability of the coated catalyst layer on the GDE/control cathode was monitored by finding the loss in the weight of the electrode before and after 50 hours of continuous electrolysis. The GDE/control was carefully removed from the flow cell and was rinsed gently with DI water to remove salts. The mass of the electrode was obtained after the GDE/control was dried with an infrared light. The same procedure was followed for the Foam electrode.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

“Current efficiency” or “faradaic efficiency” refers to the proportion of the electrons delivered to or removed from an electrode that yield a desired product as opposed to an electrochemical side reaction such as hydrogen evolution or oxygen evolution.

“Porosity” is defined as the ratio of the volume of pores in a material to the total volume of the material.

“Transition metal” refers to a chemical element that has valence electrons, i.e., electrons that can participate in the formation of chemical bonds, in two shells. In other words, transition metals are elements with partially filled d orbitals. Transition metals are located in the d-block of the periodic table, occupying groups 3 to 12 on the periodic table.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention.

This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

For example, described processes may be varied by one or more of altering the order of steps or blocks; deleting, moving, adding, subdividing, combining, and/or modifying steps or blocks; and/or performing processes or blocks described as being performed sequentially in parallel or vice versa.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B even if A and B are described in different sentences or paragraphs or with reference to different drawings (unless the description states otherwise or features A and B are fundamentally incompatible).

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1.-93. (canceled)

94. A method of electrolyzing a carbon-containing ion, the method comprising:
applying an electrical potential between an anode and an electrode of an electrochemical cell comprising an ion exchange membrane separating the anode and the electrode, wherein the electrode comprises a metallic material having a plurality of pores distributed throughout the electrode;
dissociating, within the ion exchange membrane, water into hydrogen ions and hydroxide ions;
permeating the hydrogen ions and the hydroxide ions out of the ion exchange membrane, the hydrogen ions permeating towards the electrode and the hydroxide ions permeating towards the anode;
chemically reacting, at the ion exchange membrane, the hydrogen ions with the carbon-containing ion to form one or more carbon-containing intermediate products; and
electrochemically reducing, at the electrode, one of the carbon-containing intermediate products to form one or more carbon-containing resulting products.

95. The method as defined in claim 94 wherein the carbon-containing ion is bicarbonate or carbonate.

96. The method as defined in claim 94 wherein the one or more carbon-containing intermediate products comprises carbon dioxide.

97. The method as defined in claim 95 wherein the one or more carbon-containing resulting products comprises carbon monoxide.

98.-99. (canceled)

100. The method as defined in claim 94, wherein the faradaic efficiency of the reaction performed at the reducing step is greater than 40%.

101. The method as defined in claim 100, wherein the electrical potential applied across the electrodes introduces a current density I/A at the electrode in the range of 50 to 1000 mA cm⁻² where I is electrical current and A is the geometrical surface are of the electrode.

102. The method as defined in claim 94 wherein a surface of the electrode is hydrophilic.

103. (canceled)

104. The method as defined in claim 94, wherein the porosity of the electrode is in the range of from about 40% to about 90%.

105. (canceled)

106. The method as defined in claim 94, wherein the electrochemically active surface area of the electrode is in the range of from about 0.10 m²/g and about 0.3 m²/g.

107. The method as defined in claim 94, wherein an operating pressure at the electrode is in the range of from about 4 atm to about 10 atm.

108. The method as defined in claim 94, wherein the concentration of the carbon-containing ion in the carbon-containing solution is in the range of from 0.1M to 6 M.

109. The method as defined in claim 94, wherein the concentration of the carbon-containing ion in the carbon-containing solution is in the range of from 4 M to 6 M.

110. The method as defined in claim 94, wherein the operating temperature is in the range of from 20° C. to 80° C.

111. (canceled)

112. The method as defined in claim 94, wherein the metallic material comprises one or more transition metals.

113. The method as defined in claim 94, wherein the metallic material comprises silver (Ag).

114. The method as defined in claim 94, wherein the electrode is made of a foam material.

115. The method as defined in claim 94, wherein the electrode comprises a free-standing silver foam.

116. The method as defined in claim 94, comprising treating the electrode to increase an electrochemically active surface area of the electrode.

117. The method as defined in claim 116, wherein treating the electrode comprises etching the electrode.

118. The method as defined in claim 117, wherein etching the electrode comprises immersing the electrode in acid.

119. The method as defined in claim 116, wherein treating the electrode comprises depositing a nanosized catalyst on a surface of the electrode, wherein the nanosized catalyst comprises any one of nanowires, nanorods, nanoparticles, or nanocubes.

120. (canceled)

121. The method as defined in claim 94, further comprising heating the carbon-containing solution to a temperature in the range of from about 60° C. to 80° C. prior to the reacting step.

122.-143. (canceled)
